(19) United States
(12) Patent Application Publication
(10) Pub. No.: US 2024/0034593 A1
(43) Pub. Date: Feb. 1, 2024

(54) ELEVATOR, METHOD FOR CONTROLLING AN ELEVATOR

(71) Applicant: Inventio AG, Hergiswil (CH)

(72) Inventor: Valerio Villa, Colverde (IT)

(21) Appl. No.: 18/258,253

(22) PCT Filed: Dec. 22, 2021
(86) PCT No.: PCT/EP2021/087203

§ 371 Date: Jun. 19, 2023

(30) Foreign Application Priority Data
Dec. 22, 2020 (EP) 20216358.0

(51) Int. Cl. B66B 1/34; B66B 13/14; B66B 5/16; B66B 1/06; B66B 7/12; B66B 1/36; B66B 13/22

(52) U.S. Cl. CPC B66B 1/3438; B66B 13/146; B66B 5/16; B66B 1/3446; B66B 1/06; B66B 1/3492; B66B 1/3476; B66B 7/1215; B66B 1/36; B66B 13/22

(57) ABSTRACT

An elevator includes a shaft, a car movable in the shaft, a drive operatively connected to the car and by which the car can be moved, a brake, a plurality of shaft doors and a safety control system. The safety control system has a secure safety control unit of a first type and at least one secure safety control unit of a second type. The safety control unit of the first type and the at least one safety control unit of the second type are interconnected. The at least one safety control unit of the second type collects a state of any of the shaft doors. The safety control system is adapted such that the state of each of the shaft doors can be collected directly only by one of the safety control unit of the second type.

### FIELD

The present invention relates to an elevator, in particular an elevator comprising a safety control system, and to a method for controlling an elevator.

### BACKGROUND

Elevators are used in general to convey people or objects in a vertical direction. Safety control systems are used in order to prevent danger to the person or the objects in the process. The systems monitor current operating states of the elevator, for example using sensors, i.e., for example on the basis of data or signals from sensors. Furthermore, when an unsafe state of the elevator is detected, the safety control system can activate actuators which are intended to transfer the elevator system into a safe state. The safety brake is, for example, such an actuator. Thus, for example, the safety control system monitors a speed of the elevator. If an unsafe state is detected, the safety control system activates certain actuators. For example, a catch device for braking the elevator car is activated. The safety control system additionally ensures that no further calls are handled. The safety control system is subject to extremely high demands with regard to reliability and safety.

From the prior art, elevators are known which comprise a central safety control system. These central safety control systems are connected to a plurality of sensors and actuators which are arranged at different positions within the elevator. If an unsafe operating state of the elevator is determined by the central safety control system, in particular by the sensors which are connected to this central safety control system, the central safety control system controls one or more activatable actuators in a suitable manner, in order to return the elevator to a safe state. For example, when an open shaft door is detected, the movement of the car in the elevator shaft is prevented. This can take place, for example, by triggering the actuator of the safety brake. In such a system, signals from the sensors distributed in the elevator shaft are transmitted unprocessed to the central safety control system, which alone, that is to say exclusively, processes and interprets the data, in order to subsequently directly activate the actuators.

A disadvantage of such a central safety control system is that the signal transit times can be very long. This is the case in particular in elevators having a large number of floors. However, the central architecture may also result in a delay in the transmission of the data of the sensors, as well as the intervention of the actuators, in the case of elevators having only a few floors. This is further exacerbated by the utilization of the central safety control system with a plurality of monitoring functions since the computing capacity of the central safety control system is limited. Thus, reaction delays in the elevator can occur. This in turn impairs the safety of the elevator.

EP 2 022 742 A1 discloses an elevator comprising a decentralized safety control system. The decentralized safety control system has a plurality of safety control units, the safety control units being interconnected via a bus connection.

US 2011/302466 A1 discloses an elevator comprising a safety control system which comprises a master unit and a plurality of slave units. The slave units are each connected to sensors and switches, the slave units transmitting signals of these sensors and switches to the master unit. The master unit processes the data and, if necessary, activates actuators in order to transfer the elevator into a safe state.

A disadvantage of the known safety control systems is that delays arise due to the architecture of the system. Thus, the reaction of the elevator to unsafe states is unnecessarily delayed.

### SUMMARY

It is therefore an object of the present invention to provide an elevator which avoids the disadvantages of the prior art, and in particular to provide an elevator and a method for controlling an elevator, in which delays in the safety control system are reduced as much as possible and the safety control system is simplified, so that the elevator can react as quickly as possible to unsafe states.

The object is achieved by an elevator and by a method for monitoring an elevator according to the following description.

According to the invention, the elevator comprises a shaft, a car which can move in the shaft, a drive which is operatively connected to the car and by means of which the car can be moved, a brake, a plurality of shaft doors, and a safety control system. The safety control system comprises a secure safety control unit of a first type and at least one secure safety control unit of a second type. The safety control unit of the first type and the at least one safety control unit of the second type are interconnected. The at least one safety control unit of the second type is designed such that a state of each of the shaft doors can be collected thereby. According to the invention, the safety control system is designed such that the state of the shaft doors can be collected directly exclusively by the at least one safety control unit of the second type.

It has proven advantageous that, by the presence of two separate secure safety control units, by the clear assignment of the shaft doors to the at least one safety control unit of the second type, and by the exclusive direct collecting of the state of the shaft doors by the at least one safety control unit of the second type, the safety control units can be designed specifically for the collecting task assigned to them. Collecting the shaft door state is safety-relevant since persons in the vicinity of the shaft are at risk when the shaft door is open. Furthermore, the movement of the car is to be prevented or at least restricted when the shaft door is open. The secure safety control unit of the second type provides a safety control unit according to the invention, which is designed for this task. It is also important that all shaft doors are monitored. The at least one safety control unit of the second type is designed to be secure, such that it is ensured that the collecting of the state of the shaft doors is reliable. The safety control system can thus leave the monitoring of the state of the shaft doors exclusively to the safety control unit of the second type and be sure that this safety control unit reliably carries out the monitoring. A finally and reliably ascertained state of the shaft doors, i.e., a simple “door(s) closed/door(s) not closed,” can subsequently be transmitted in the safety control system via the connection to other units, in particular to the secure safety control unit of the first type. It is thus made possible, inter alia, to implement a speed request specific to the monitoring of the shaft doors in the safety control unit of the second type. The monitoring of each of the shaft doors by the at least one safety control unit of the second type makes it possible to design the safety control unit of the first type and, if applicable, a further safety control unit that is present, in a manner free of a door-specific requirement. This allows a simple, efficient and secure safety control system to be provided.

A safety control unit, which meets, for example, the standardized Safety Integrity Level 1 (Safety Integrity Level SIL1), preferably SIL2 and particularly preferably SIL3 according to IEC61508 and/or EN8120 and/or EN8150, can be considered secure.

A state is to be understood above and in the following as a position of the shaft doors that is present at a certain point in time. In particular, the state of the shaft door can be closed or not closed, i.e., open. While the safety control unit of the second type directly exclusively collects the state of the shaft door, this does not exclude the possibility of the safety control unit of the second type forwarding information based on this collected state within the safety control system, for example to the secure control unit of the first type. The exclusive and immediate collecting means that the evaluation of the sensor signal(s) and the derivation of the state from the signal(s) are exclusively carried out by and in the safety control unit of the second type. That is to say that the safety control unit of the second type finally collects this state without the aid of a different safety control unit of another type.

In a preferred embodiment of the elevator, the safety control system comprises one secure safety control unit of the second type per shaft door. The safety control units of the second type are preferably attached to the shaft doors. A safety control unit of the second type is preferably attached to each of the shaft doors.

This makes it possible for each of the shaft doors to have a safety control unit of the second type provided specifically for this shaft door. The safety control unit of the second type can thus be of comparatively simple design, since it has to monitor only one shaft door. In this embodiment, the safety control unit of the second type is preferably arranged on the shaft door, as a result of which the safety control unit of the second type is directly by the shaft door and delays by transmission of signals can thus be further reduced. Since the safety control unit of the second type is a secure safety control unit, the connection to at least some of the sensors and/or actuators, in particular a door lock sensor and door lock actuator, must be designed to be secure. Due to the arrangement directly at the corresponding shaft door, the effort of having to establish connections reliably over long distances is omitted. Furthermore, the arrangement on the shaft door proves advantageous, since in this way the safety control unit and the connections to the sensors and actuators present on the shaft door can already be produced in a factory. Installation on site by the fitter is unnecessary. This results in a simple safety control unit of the second type, which further reduces delays and thus enables increased safety of the safety control system.

A connection which satisfies, for example, the standardized Safety Integrity Level 1 (SIL1), preferably SIL2 and particularly preferably SIL3 according to IEC 61508 and/or EN81-20 and/or EN81-50, can be considered secure.

Above and in the following, “attached to the shaft door” means that the safety control unit is designed as part of the shaft door. Thus, the safety control unit can be arranged, for example, in a box above the shaft door leaf, in which the door leaves are also displaceably guided. This box can be arranged outside the shaft and/or inside the shaft. The safety control unit can alternatively also be mounted in a door post.

In a preferred embodiment of the elevator, the secure safety control units are designed such that in each case at least one actuator assigned to them can be controlled by them. The respective actuator can preferably be controlled directly exclusively by this safety control unit.

By means of the assignment of an actuator to a safety control unit and by means of the direct exclusive actuation of this actuator by means of the safety control unit, the two components can be matched to one another in their design. Thus, the safety control unit can, for example, be matched to the type of actuator with respect to computation rate, i.e., evaluation speed. Thus, the safety control unit of the second type can be designed having a different evaluation speed, for example a lower evaluation speed, and accordingly also having a different sensor readout rate, for example a lower readout rate, than for example the safety control unit of the first type. Thus, for example, the safety control unit of the second type can be designed for the processes on the shaft door, without the need to simultaneously also be designed for processes of safety-relevant braking of the car. In contrast, the safety control unit of the first type can be designed exclusively for the evaluation required for the emergency braking (catch). A cost-effective and nevertheless secure safety control system having different safety control units tailored to the purpose thereof can thus be formed.

An actuator is to be understood above and in the following as a component by which the physical state of the elevator can be changed (or retained against other effects). For example, each of the brake, in particular also the safety brake, and the drive, in particular also door drives, and door lock, is an actuator. Above and in the following, an actuator which is actuated directly exclusively by a safety control unit means that the specific actuation by means of the required signals and energy for the change of state of the actuator takes place exclusively via the safety control unit that is assigned in each case. This does not rule out the possibility that the safety control unit assigned to the actuator may receive the abstract indirect command from another safety control unit, to change the state. In order for the safety control unit to be able to directly control the associated actuator exclusively, the sensors required for this purpose, which make it possible to collect the state of the actuator, are connected to the safety control unit. The safety control unit thus enables the implementation of a closed control loop of the actuator without having to resort to remote signals and/or evaluation capacity or information of other safety control units in the process.

In a preferred embodiment of the elevator, each shaft door comprises, as an actuator, a secure door lock and/or an active door drive. The safety control system is designed such that the door locks and/or the door drives can be controlled directly exclusively by the at least one safety control unit of the second type.

In a first state, a door lock blocks opening of the shaft door, and in a second state it does not block this, i.e., it enables the opening of the door. If the door lock is designed such that the state in which the door lock blocks the opening of the door can be assumed only when the door or the door leaves is/are also in a blockable state (in other words, the door lock is designed to be “fail-safe” and can therefore be designated as secure), it is possible to conclude whether the shaft door is closed and blocked or open (not closed) and unblocked, solely by the monitoring of the two states “blocked” or “not blocked” of the door lock. A secure safety control unit of the second type assigned to the door lock can thus be provided, which can exclusively directly determine a secure state of the elevator in relation to the shaft door, i.e., without further sensors or actuators. For example, the door lock can be designed as a bolt that can be secured by an electromagnet. The bolt can preferably only move into a closed state by means of gravity when the door leaves are closed and the electromagnet is currentless. That is to say that the door leaves block the downward falling of the bolt, caused by gravity, as long as the doors are not closed. The monitoring of the position of the bolt thus makes it possible for a fail-safe door locking to be carried out, from which the shaft door state can be collected easily and reliably. Furthermore or as an alternative, the shaft door can also be provided with an active drive. The combination of secure safety control unit and active drive, which can be controlled directly and exclusively by the secure safety control unit, also makes it possible to ensure the state of the shaft door locally, i.e., exclusively by the two components (safety control unit/drive) and possibly sensors connected to the safety control unit, for example sensors for detecting the position of the door leaves (or position of the locking bolt). The combination safety control unit and the active door drive can thus collect the critical state of open shaft doors. Thus, by calling up the door state from the safety control unit of the second type, the control system can ensure that the car in the shaft is only moved when a secure state is present. The advantage of a door lock and/or of an active drive, as described above and in the following, is that there are no unexpected door opening movements. An elevator can thus be constructed in which the shaft door is controlled exclusively (i.e., an unexpected opening of a shaft door by a service technician using a triangular key, as is provided in many elevator systems, is not possible) by the secure safety control unit of the second type. An unexpected opening, for example by a fitter, does not have to also be taken into account in the design of the safety control system. This reduces in particular the speed requirements for the safety control system with respect to the readout and evaluation speed. Thus, sensors can in each case be queried exclusively after a state change that is ordered by the system. In this way, the need for rapid collecting of the state of the shaft doors, designed for detection of unforeseen events, is eliminated.

Furthermore, the fail-safe design of the communication means that the connection between the safety control unit of the second type and the safety control unit of the first type can be designed as simple, non-secure wireless connections. This makes it possible to integrate the safety control unit of the second type, which is preferably present at each shaft door, into the safety control system in a simple and cost-effective manner.

A non-secure connection is a connection which does not meet a standardized Safety Integrity Level or, if appropriate, also meets a lower Safety Integrity Level than that prescribed by the relevant standard, for example EN61508 and/or EN8120 and/or EN8150. What is known as “black channel” communication is thus implemented, in which two secure units communicate securely with one another via a non-secure connection.

In a preferred embodiment of the elevator, the state ascertained by the safety control unit of the second type is a state of the door lock and/or of the door drive. In this case, the state signals a closed or a non-closed shaft door.

If the communication is limited to the exchange of status information in the form of binary information (“door closed” corresponds to a secure state/“door not closed” corresponds to a non-secure state), the receiving safety control unit can evaluate failure to receive this status information as a “door not closed”, or in other words as a non-secure, state. There is thus no longer any need to carry out this communication securely, since the state to be transmitted enables the transmission in a “fail-safe” manner. Thus, the need for secure communication is limited to the safety-relevant actuators and sensors, which are attached in the secure safety control unit of the second type itself.

In a preferred embodiment of the elevator, the safety control system is designed such that the brake can be controlled directly exclusively by the safety control unit of the first type, the safety control unit of the first type and the brake preferably being arranged on the car.

Thus, only the safety control unit of the first type needs to be designed for the requirement of safe braking of the elevator car. The preferred arrangement of the safety control unit of the first type in the physical proximity of the brake minimizes reaction delays due to transmission delays.

In a preferred embodiment of the elevator, the safety control unit of the second type is designed such that the safety control unit of the second type transmits a signal, for checking the communication, to the safety control unit of the first type, at regular intervals. This interval is, for example, longer than 1 s, preferably longer than 30 s, and particularly preferably longer than 1 min.

As a result of the regular transmission of a signal for checking the communication between the safety control unit of the second type and the safety control unit of the first type, it can be ensured that the safety control unit of the first type, that is to say the receiver unit of the status information, is informed at regular intervals that the communication between the two units still functions. If the safety control unit of the first type knows that the communication functions and further also that the safety control unit of the second type has recently transmitted status information relating to the secure state of the shaft door, the elevator has not initiated a change in state of the shaft doors, and that unexpected state changes of the shaft doors are not possible, the safety control unit of the first type can thus reliably conclude a secure state of the elevator in the region of the shaft doors. Details regarding the state of the door, i.e., sensor information of the sensors around the door, are not necessary, for this purpose, in the safety control unit of the first type.

In a preferred embodiment of the elevator, the safety control system comprises at least one safety control unit of a third type. The safety control unit of the third type enables a Safe Torque Off of the drive. The safety control unit of the first type and the safety control unit of the third type are connected to each other.

The safety control unit of the third type makes possible the safety-relevant function of safely switching off the torque (Safe Torque Off), which is to be performed by the actuator drive. It is thus ensured that the safety control unit of this actuator is also formed separately from the other safety control units and, as a result, can be arranged directly next to or in the immediate vicinity of the drive as far as possible, whereby delays on account of transmission delays can be further reduced.

In a preferred embodiment of the elevator, a connection between the safety control units is designed as a wireless and/or cable connection. In particular, the connection of the safety control unit of the third type to the safety control unit of the first type is designed as a cable connection. The connection between the safety control unit of the first type and the at least one safety control unit of the second type is preferably designed as a wireless connection, particularly preferably as a non-secure wireless connection.

The signal of the safety control unit of the third type is a binary signal which enables the drive in a first state to operate in the normal operating state and which, in the second state, interrupts the connection of the converter to the machine, for example by electromagnetic contactors which separate the connection, or by semiconductor switches which ensure that current no longer flows into the machine. Due to the binary nature of this signal, the connection can be implemented very easily, for example, by a two-wire cable connection. In addition, the communication is unidirectional since the safety control unit of the third type, at least in its simplest embodiment of the Safe Torque Off, does not send a confirmation or status information back to the safety control unit of the first type.

In a further embodiment, the safety control unit of the third type is an independent safety control unit which is in bidirectional communication with the safety control unit of the first type. In this case, the communication can be constructed in the same way as the communication between the safety control unit of the first type and the safety control unit of the second type.

As described above and in the following, the embodiment of the elevator according to the invention limits the communication within the safety control system, that is to say between the safety control units of the first type and the safety control unit of the second type, to a minimum, and is designed such that the communication is fail-safe, that is to say that an absence of communication is evaluated as a non-secure state. The requirement for the connection between these safety control units is therefore low. This is particularly advantageous since the safety control unit of the second type can be arranged on the car, at the respective shaft doors and the safety control unit of the first type. For example, a wireless module can be present in the shaft door, which transmits the status information of the safety control unit of the second type, a corresponding wireless receiver being present in the safety control unit of the first type, which receives this information. A simple and cost-effective connection between the units can thus be realized. In particular, complicated wiring of the shaft doors and the connection thereof to the car via a hanging cable are omitted.

In a preferred embodiment of the elevator, the safety control unit of the first type and/or the safety control unit of the second type comprises a non-secure interface for connection to sensors and/or actuators. In particular, the safety control unit of the second type comprises a non-secure interface for connection to a sensor for detecting the presence of a car door, preferably a magnet sensor, and optionally for connection to a shaft door drive unit for controlling the shaft door movements. In particular, the safety control unit of the first type comprises a non-secure interface for connection to position sensors and/or speed and acceleration sensors.

A non-secure interface is an interface which does not fulfill a standardized Safety Integrity Level or, if appropriate, also a deeper Safety Integrity Level than that prescribed by the relevant standard, for example EN61508 and/or EN8120 and/or EN8150.

While certain sensors for collecting a secure state of the monitored actuator/actuators are indispensable, further actuators and/or sensors which collect/cause safety-relevant states can be present. For example, in the case of a shaft door having an active door drive and a fail-safe door lock, the sensor for detecting the state of the door lock can, alone, already fulfill the required safety requirements in relation to the shaft doors. A sensor which monitors the door movement on the basis of the active drive is not safety-relevant in this case and therefore does not have to be designed to be secure. Thus, in this case, the door movement sensor can be connected to the secure safety control unit of the second type via the non-secure interface.

In a preferred embodiment of the elevator, the safety control unit of the first type and/or the safety control unit of the second type comprises a secure interface for connection to sensors and/or actuators. In particular, the safety control unit of the second type comprises a secure interface for connecting a door lock status sensor, and an interface for actuating the electromagnet (actuator) of the door lock. In particular, the safety control unit of the first type comprises a secure interface for connecting a slack cable detector and a load measuring device, as well as a secure interface for actuating the brake and/or the Safe Torque Off function (in the form of a signal from the safety control unit of the first type for triggering the STO state (separation of the machine from the converter) or a connection to a separate, independent secure safety control unit of the third type, which implements the STO function).

An interface which meets, for example, the standardized Safety Integrity Level 1 (SIL1), preferably SIL2 and particularly preferably SIL3, according to IEC61508 and/or EN8120 and/or EN8150, can be considered secure.

The secure interface enables the connection of the actuators and sensors that are relevant to the security state of the elevator, and thus enables a secure safety control system to be provided by providing self-contained secure safety control units.

The object is also achieved by a method for controlling an elevator, preferably as described above and in the following, the method comprising the steps of:
collecting a secure state of at least one, preferably all, shaft doors of a plurality of shaft doors by collecting a secure state of an actuator of the shaft door by at least one secure safety control unit of a second type, the collected state in particular signaling either “closed” or “not closed”,
transmitting, in particular non-securely transmitting, in particular transmitting via a wireless connection, the ascertained state of the at least one, preferably all, shaft doors from the at least one safety control unit of the second type to a safety control unit of a first type.

In the method described above and in the following, the state of a shaft door is indirectly ascertained, i.e., assessed, by means of the state of an actuator. If the actuator is designed to be secure, i.e., for example fail-safe, a secure state can be collected indirectly by collecting the state of this secure actuator. For example, a fail-safe door lock or an active, secure door drive can be used as an actuator for indirectly collecting the secure state.

An actuator is suitable for indirectly monitoring the state of the object which can be actuated directly or indirectly by the actuator, that is to say can be controlled by the actuator (in the present case the shaft door) when the actuator comprises a secure control and the state to be monitored (for example closed/not closed) of the object to be monitored (for example shaft door) can be changed exclusively after/by actuation of the actuator. This is because, as a result, an unexpected change in state, for example a manual opening of the shaft door by the fitter, can be ruled out. In contrast to an elevator comprising a conventional door switch, which has to determine an unexpected door opening within a very short time every time, the requirements for the safety control system of the second type, which collects the state directly, are reduced, in particular the monitored state has to be collected less often.

In this case, the state distinction “closed” and “not closed” can be ascertained by a sensor, which only determines whether the shaft door is in a closed state, in all other cases, including the case in which the sensor fails, a state “not closed” being ascertained.

In a preferred embodiment, each of the shaft doors has a secure door lock, wherein, in the method for controlling the elevator, the method further comprises the steps of:
receiving the transmitted state by the safety control unit of the first type,
enabling an opening of a brake, in particular release of a brake, by the safety control unit of the first type if all of the received states correspond to the state “closed”,
blocking an opening of the brake by the safety control unit of the first type if one of the received states is “not closed” or not all states have been received.

In a preferred embodiment of the method for controlling the elevator, the method further comprises the steps of:
repeatedly transmitting a signal for checking the communication by the safety control unit of the second type to the safety control unit of the first type, at a spacing of a defined time interval,
determining the communication capability between the safety control unit of the first type and the safety control unit of the second type upon receipt of the signal for checking the communication, and
determining a fault condition of the communication between the safety control unit of the first type and the safety control unit of the second type when the signal is not received after a period of time which is longer than the defined time interval, the defined time interval preferably being longer than 1 second, preferably longer than 30 seconds, particularly preferably longer than 2 minutes.

In a further embodiment of the method, this further comprises the step of:
transmitting the STO command or enabling STO operation from the safety control unit of the first type to the safety control unit of the third type.

Further advantages, features and details of the invention can be found in the following description of embodiments and with reference to the drawings, in which like or functionally like elements are provided with identical reference signs.

### DESCRIPTION OF THE DRAWINGS

In the drawings:

FIG. 1: shows a highly simplified and schematic illustration of an elevator comprising an elevator shaft and a car, and

FIG. 2: shows a schematic block diagram of the safety control system.

### DETAILED DESCRIPTION

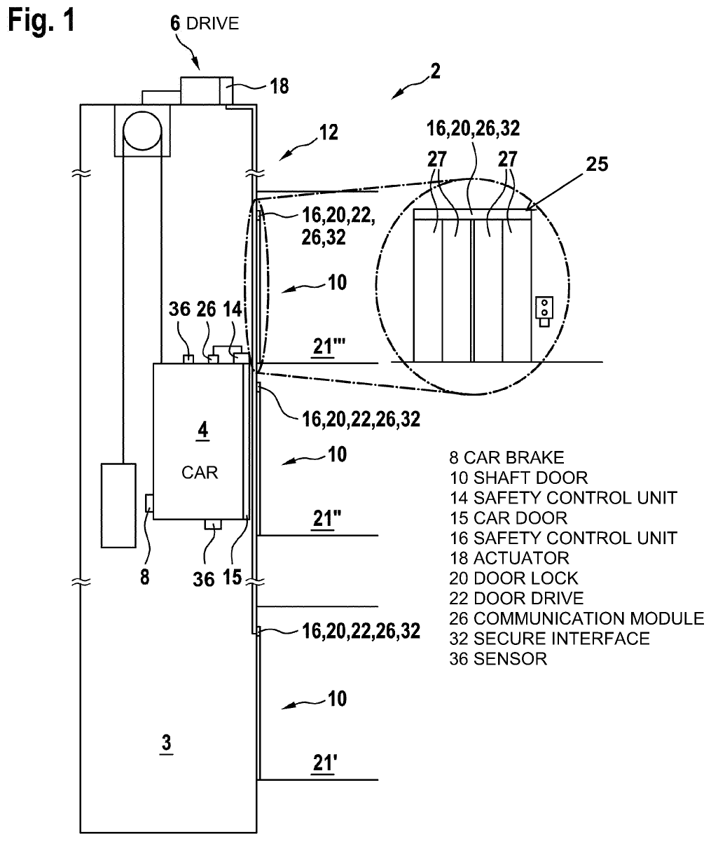

FIG. 1 shows an elevator 2. The elevator 2 is shown in a side view. A part of the elevator 2 is shown in a front view, this being indicated by the dot-dash line.

The elevator 2 comprises a car 4 which can be moved along the shaft 3. The elevator car 4 is held by a support means, the support means being, for example, a cable or a belt. At the other end, the support means is connected to a counterweight. The support means is driven by means of a drive 6.

The car 4 comprises a car door 15 for opening and closing an access to the car 4. In this embodiment, the car door is opened via an active door drive. The car door drive can be controlled via a safety control unit of a first type 14, which is arranged on the car.

At least one shaft door 10 is provided on each of the plurality of floors 21′, 21″, 21′″. The shaft door 10 can be opened or closed in order to thus allow or block access to the shaft 3. The elevator 2 further comprises an active drive on each shaft door 10. This active drive enables the opening or closing of the shaft door by a lateral displacement of the shaft door leaf. Each of the shaft doors 10 can be controlled by a separate safety control unit of a second type 16.

The elevator further comprises a car brake 8 on the car 4, the car brake 8 being controlled by the safety control unit of the first type 14.

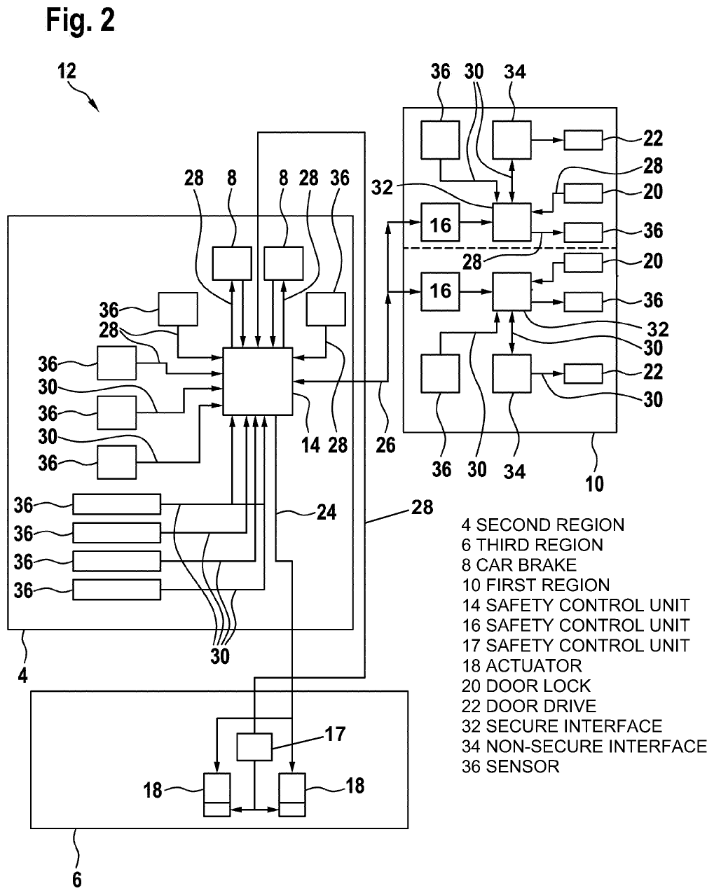

One safety control unit of the second type 16 per floor 21′, 21″, 21′″ and shaft door 10 is arranged in a yoke of the door frame 25 above the door leaves 27. Also located in this box 25 is a door lock 20 and an active door drive 22, as well as a wireless communication module for wireless connection 26 to the safety control unit of the first type 14, as well as a sensor 36 (see FIG. 2) for monitoring the state of the door lock. The safety control unit of the second type 16 comprises a secure interface 32 and a non-secure interface 34 (see FIG. 2).

In normal operation of the elevator 2, the car 4 is moved from one floor 21″ to another floor 21′. In this case, the movement of the elevator car 4 is achieved by the action of the drive 6 on the support means. In this case, the drive 6 is controlled in such a way that the car 4 stops when the corresponding floor is reached. The passengers can now get in or out.

FIG. 2 shows the safety control system 12 of the elevator 2. The safety control system 12 is subdivided schematically into three regions. A first region 10 (denoted by the border having the reference sign 10) represents the part of the safety control system 12 which is arranged on the shaft doors 10 or in the immediate vicinity of the shaft doors. A second region (denoted by the border having the reference sign 4) represents the part of the safety control system 12 which is arranged on the car 4. Furthermore, a third region exists (border having the reference sign 6), which is the part of the safety control system 12 that is arranged at the drive 6.

Two identical safety control units of the second type 16, and corresponding sensors 36 and actuators 20, 22, are shown in the region of the shaft doors 10. The secure control unit of the second type 16 is connected via a secure interface 32 and a secure connection 28 both to a first actuator 20 in the form of a door lock and to a sensor 36, this sensor monitoring the state of the door lock 20. Furthermore, the secure safety control unit of the second type 16 is connected, via a non-secure interface 34 and a non-secure connection 30, to further sensors 36, namely a magnetic sensor for detecting a car in the vicinity of the shaft door, and an actuator 22 in the form of a door drive.

In the region of the car 4, the safety control system 12 comprises a secure safety control unit of the first type 14. This safety control unit 14 is connected to a plurality of sensors 36, four sensors 36 being shown in this embodiment in the lower left corner of the region 4. One camera is connected to the car roof, and one camera is connected to the car floor, as sensors 36 as shown in FIG. 1. In this case, the camera serves at least to monitor the space in which a service technician is working during maintenance. These sensors 36 are connected via a non-secure connection 30 to the safety control unit 14 via the non-secure interface 34 (not shown). Furthermore, an acceleration sensor 36 and an absolute position sensor 36 in the left central area of the region 4 are also connected via a non-secure interface 34 and connection 30. Furthermore, three sensors 36 are connected to the safety control unit 14 via a secure connection 28. Two slack cable sensors 36 are present, and a sensor 36 for determining the weight in the car 4 are these three sensors. The safety control unit 14 is further connected, via a secure connection 28 in each case, to two actuators 8, which are brakes. The safety control unit 14 also comprises a secure connection 28 to a safety control unit of a third type 17 in the region of the drive 6, via which the STO function in the converter can be triggered. The STO function can be triggered in the alternative by the safety control unit 14 through a secure connection 24 to actuators 18.

Finally, it should be noted that terms such as “comprising,” “including,” etc. do not preclude other elements or steps, and terms such as “a” or “an” do not preclude a plurality. Furthermore, it should be noted that features or steps which have been described with reference to one of the above embodiments may also be used in combination with other features or steps of other embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. An elevator comprising:
a shaft;
a car movable in the shaft;
a drive operatively connected to the car and adapted to move the car in the shaft;
a brake at the car;
a plurality of shaft doors providing access to the shaft;
a safety control system including a secure safety control unit of a first type and a secure safety control unit of a second type, wherein the safety control unit of the first type and the safety control unit of the second type are interconnected;
wherein the safety control unit of the second type collects a state of an associated one of the shaft doors; and
wherein the state of the associated shaft door is collected directly exclusively by the safety control unit of the second type.

17. The elevator according to claim 16 wherein the safety control system includes a plurality of the safety control units of the second type, and wherein each of the safety control units of the second type is mounted on an associated one of the shaft doors.

18. The elevator according to claim 16 wherein each of the safety control unit of the first type and the safety control unit of the second type has at least one actuator associated therewith and controlled directly exclusively thereby.

19. The elevator according to claim 16 wherein the associated shaft door includes a secure door lock and/or an active door drive that operates as an actuator, and wherein the door lock and/or the door drive is controlled directly exclusively by the safety control unit of the second type.

20. The elevator according to claim 19 wherein the state collected by the safety control unit of the second type is a state of the door lock and/or the door drive and the state signals that the associated shaft door is closed or non-closed.

21. The elevator according to claim 16 wherein the brake is controlled directly exclusively by the safety control unit of the first type, the safety control unit of the first type is attached to the car, and the brake is a car brake.

22. The elevator according to claim 16 wherein the safety control unit of the second type controls an actuator, and when the actuator is in an unsafe state, the safety control unit of the second type transmits status information representing the unsafe state to the safety control unit of the first type.

23. The elevator according to claim 16 wherein the safety control unit of the second type transmits a signal to the safety control unit of the first type at predetermined regular intervals to check communication between the two safety control units, the regular interval being at least one second.

24. The elevator according to claim 23 wherein the regular intervals are at least one minute.

25. The elevator according to claim 16 wherein the safety control system includes a safety control unit of a third type connected to the safety control unit of the first type, the safety control unit of the third type adapted to implement a Safe Torque Off state of the drive.

26. The elevator according to claim 25 wherein the safety control unit of the third type and the safety control unit of the first type are connected by a cable connection.

27. The elevator according to claim 16 wherein the safety control unit of the first type and the safety control unit of the second type are connected by a non-secure wireless connection.

28. The elevator according to claim 16 wherein the safety control unit of the first type includes a non-secure interface and/or the safety control unit of the second type includes a non-secure interface, the non-secure interface of the safety control unit of the second type being connected to a shaft door drive unit of the associated shaft door, and the non-secure interface of the safety control unit of the first type being connected to at least one of a position sensor, a speed sensor and an acceleration sensor at the car.

29. The elevator according to claim 16 wherein the safety control unit of the first type includes a secure interface being connected to at least one of a slack cable sensor, a load measurement sensor, an actuator for actuating the brake and a safety control unit of a third type adapted to implement a Safe Torque Off state of the drive.

30. A method for controlling the elevator according to claim 16, the method comprising the steps of:
operating the safety control unit of the second type to collect the state of the associated shaft door by collecting a state of an actuator of the associated shaft door wherein the collected state of the actuator signals either “closed” or “not closed” as the collected state of the associated shaft door; and
transmitting the collected state of the associated shaft door from the safety control unit of the second type to the safety control unit of the first type via a non-secure connection.

31. The method according to claim 30 wherein the non-secure connection is a wireless connection.

32. The method according to claim 30 further comprising the steps of:
receiving the transmitted collected state by the safety control unit of the first type;
enabling an opening of the brake when the received collected state signals “closed” by the safety control unit of the first type releasing the brake; and
blocking an opening of the brake by the safety control unit of the first type when the received collected state signals “not closed”.

33. The method according to claim 30 further comprising the steps of:
repeatedly transmitting a check communication signal by the safety control unit of the second type to the safety control unit of the first type at a defined time interval;
determining that a communication capability between the safety control unit of the first type and the safety control unit of the second type functions upon receipt of the check communication signal by the safety control unit of the first type; and
determining a fault condition of the communication capability between the safety control unit of the first type and the safety control unit of the second type when the check communication signal is not received by the safety control unit of the first type after a period of time that is longer than the defined time interval.

34. The method according to claim 33 wherein the defined time interval is at least 2 minutes.
